(19) United States
(12) Patent Application Publication
(10) Pub. No.: US 2003/0000310 A1
(43) Pub. Date: Jan. 2, 2003

(54) Pressure regulating device

(76) Inventor: Ardishir Rashidi, Upland, CA (US)

Correspondence Address: Ardishir Rashidi, 1408 Forest St., Upland, CA, 91784, US

(21) Appl. No.: 09/893,765

(22) Filed: Jun. 27, 2001

(51) Int. Cl. G01F 1/68

(52) U.S. Cl. 73/714; 73/204.11

(57) ABSTRACT

A pressure regulating device with the wetted surfaces and a sensing element operated by a reference control pressure made for control and regulation of highly corrosive fluids. It includes a body member having an inlet and an outlet passageway separated from one another by the engagement of a tongue and groove seal joint of a sensing element and a controlling element assembled on to the body. Applying a reference control pressure to the top side of the sensing element disengages the seal joint which allows fluid at high pressure to flow into the outlet passageway and under the sensing element opposite to the reference control pressure side. Once force produced by pressure under sensing element equals to the force produced by reference control pressure on top of the sensing element, the seal joint closes to prevent further flow. As the fluid in the outlet is consumed, it results in drop of pressure under the sensing element, hence producing an unbalanced force at the seal joint causing it to open and allowing fluid flow to resume. Control of forces by design features of the sensing and controlling elements allow continuous operation of the device to control pressure at the outlet with precise proportion to the reference control pressure applied to the top of the sensing element.

### BACKGROUND OF THE INVENTION

Pressure regulating devices commonly known as Pressure Regulators, are used in a variety of manufacturing industries that require processing liquids and chemical fluids. As discussed in U.S. Pat. No. 5,852,244, and U.S. Pat. No. 6,250,329, it is necessary in the manufacturing of semi-conductor wafers, pharmaceutical and products requiring high purity fluids to manufacture, to employ fluid control components which do not contaminate the product as produced. The manufacturing of semiconductor wafers requires that, an efficient amount of several and highly corrosive chemicals to be delivered to the point of use at precisely controlled pressure. It is desirable to have a Pressure Regulating device with wetted surfaces made from fluorocarbon polymer such as Teflon, that is used for efficient delivery and usage of chemicals in critical applications. In the device disclosed in U.S. Pat. No. 5,852,244 two sensors are installed to measure differential pressure across an orifice for measurement of flow. In the U.S. Pat. No. 6,250,329, a Snap Open Pressure Relief Valve is described for save operation of chemical processing system against over pressurization. Consequently, it is desirable to provide a Pressure Regulating Module, which makes precise control of chemical delivery in critical fluid applications such as silicon wafer and pharmaceutical manufacturing processes possible.

### SUMMARY OF THE INVENTION

In accordance with this invention, precise control of fluid pressure is possible for optimum usage and delivery of corrosive chemicals to the point of use. The chemically inert material is not reactive with highly corrosive fluids that have extreme pH levels either, highly acidic or basic.

This invention has several features, no single one of which is solely responsible for its desirable attributes. Without limiting the scope of this invention as expressed by the claims that follows, its more prominent features will now be discussed briefly. After considering this discussion, and particularly after reading the section entitled, “DETAILED DESCRIPTION OF THE PREFERRED EMBODIMENTS”, one will understand how the features of this invention provide its benefits, which include, but not limited to:

(a) an innovative “Poppetless Pressure Regulator” with the wetted parts made from Fluorocarbon polymer and that it can be operated as a closed loop programmable module or stand-alone Pressure Regulator unit,

(b) a novas poppetless design with a high sensing to control elements ratio,

(c) ease of a integrating a corrosive resistance pressure sensor to monitor the output of the pressure regulator,

(d) an electronically controlled pneumatic board that upon receiving a signal from the built-in pressure sensor, it will adjusts pressure proportionally to the reference port of the regulator to subsequently control the pressure output of the regulator,

(e) minimized externally exposed metallic surfaces and

(f) lower maintenance

The advantage of this device is that it is adapted to regulate the incoming pressure of a corrosive fluid a) as a stand-alone in-line unit or b) as an integrated module for remote programmability to control the process line pressure.

As a stand-alone unit, the first feature of the pressure regulator device of this invention is that it is adapted to regulate the incoming pressure of a corrosive fluid. The device include an inlet into which fluid with unregulated pressure is introduced a reference port to which a desired pressure is applied and an outlet from which fluid with controlled pressure corresponding to the reference pressure exits.

The second feature is that the innovative design of the device minimizes number of components to produce one unit assembly. In addition to its low profile, it allows for uni-directional assembly of components hence, reducing manufacturing and maintenance cost.

The third feature is the innovative design of the sensing and controlling elements. The sensing element has a large effective area with an opening which allows for uni-directional installation of the pressure controlling element. The ratio of effective area of the sensing element to the controlling element exceeds 20 to 1 which allows for fast response and precise control of out going pressure.

The fourth feature is the innovative design of the controlling element allows a large flow path for the fluid to exit from the inlet port to the outlet port. This create an equivalent large orifice with low resistance to flow which results in a regulator with high Cv rating.

The fifth feature is that the device includes a clamping mechanism that applies a uniformly distributed tie down load on the sensing element that secures a tongue and groove sealing joint. The clamping mechanism includes metallic elements that are enclosed with chemically inert housing. This clamping mechanism includes a retainer flange that overlies the sensing element and has an interior surface that bears against the exterior surface of the sensing element. The retaining flange also provides means for integrating the reference pressure port components to complete the device assembly.

### DESCRIPTION OF THE DRAWING

The preferred embodiments of this invention, illustrating all its features, will now be discussed in detail. These embodiments depict the novel and non-obvious pressure regulating device of this invention as shown in the accompanying drawing, which is for illustrative purposes only. This drawing includes the following Figures (FIGS. ), with like numerals including like parts:

FIG. 1 is a top view of the pressure regulating device of this invention.

FIG. 2 is a front view of the pressure regulating device of this invention

FIG. 3 is a cross section taken along the line 1-1 in FIG. 1, showing the major internal components of the device.

FIG. 4 is an exploded cross-sectional view of the pressure-regulating device shown

FIG. 5 is a cross-sectional view showing detail features of the retaining flange of this invention

FIG. 6 is a cross-sectional view showing detail features of the sensing element of this invention

FIG. 7 is a cross-sectional view showing detail features of the body of this invention

FIG. 8 is a cross-sectional view showing detail features of the reference pressure port of this invention

FIG. 9 is a cross-sectional view showing detail features of the spring retainer of this invention

FIG. 10 is a cross-sectional view showing detail features of the sensing element plug of this invention

FIG. 11 is a cross-sectional view showing detail features of the controlling element of this invention

FIG. 12 is a cross-sectional view showing detail features of the second embodiment of this invention

### DESCRIPTION OF THE PREFFERED EMBODYMENTS

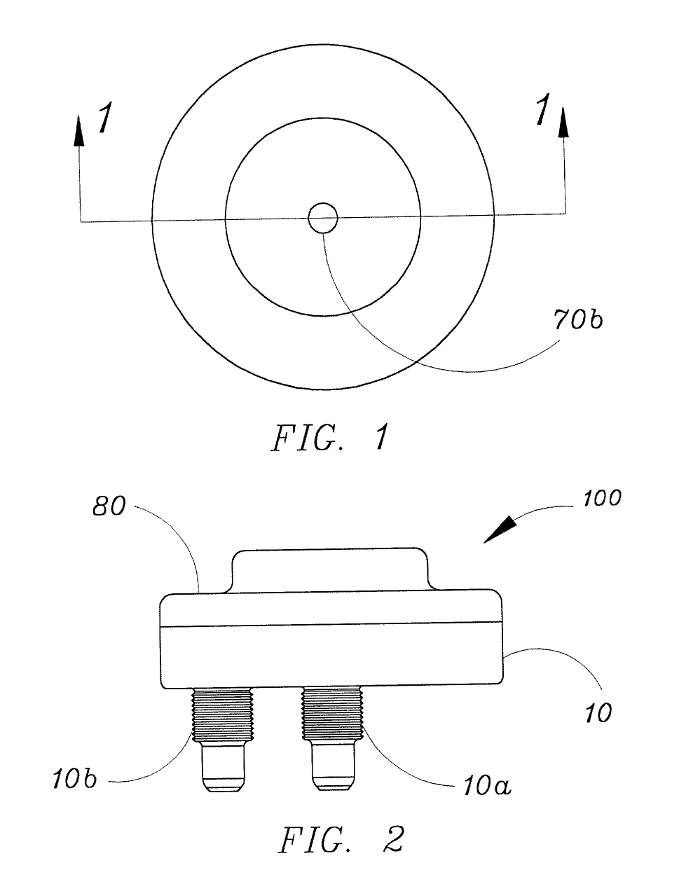

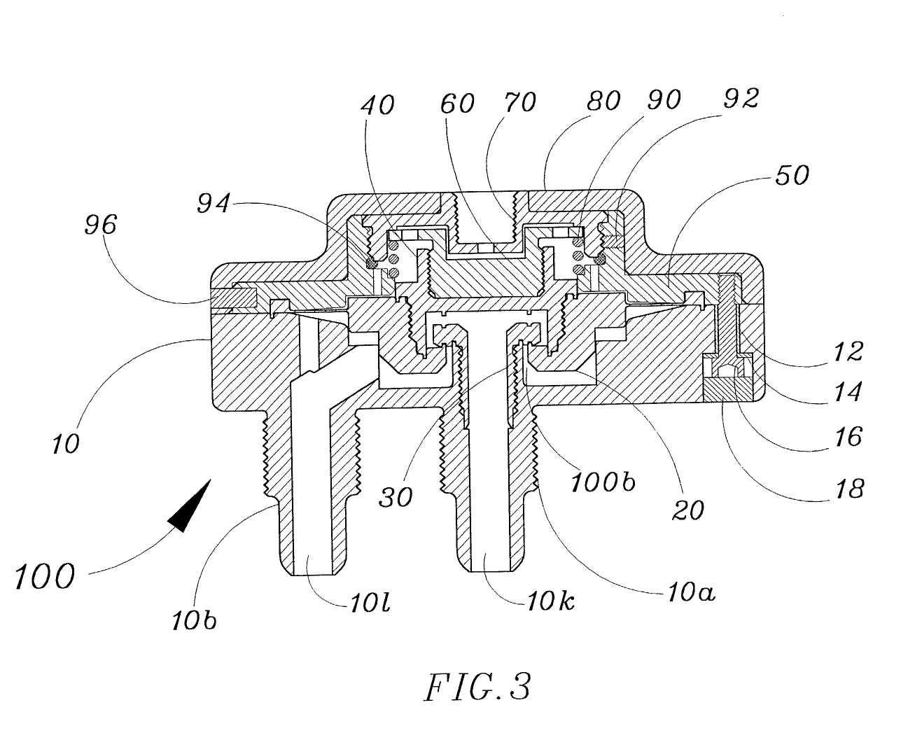

As shown in FIGS. 1 through 3, the pressure regulating device 100 of this invention includes, a body member 10, a sensing element 20, a controlling element 30 and an element plug 40 all of which are made of an inert material that does not react with corrosive processing fluid (not shown). Said pressure regulating device, further includes, a retaining flange 50, a spring 90, a spring retainer 60, an “O” ring 94, a reference pressure port 70, a set screw 92 an chemically inert cover 80, a plurality of chemically inert lock pins 96 located circumferentially, a plurality of radially located clamping hardware, sleeve 12, washer 14, and fastener 16 to clamps down the sensing element 20, and plurality of chemically inert plugs 18.

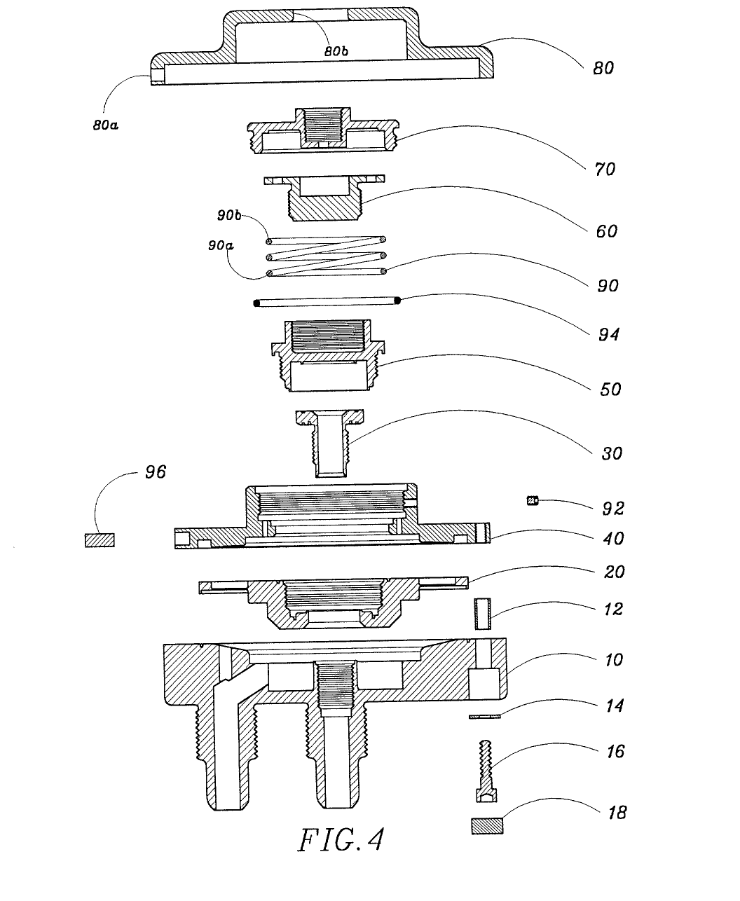

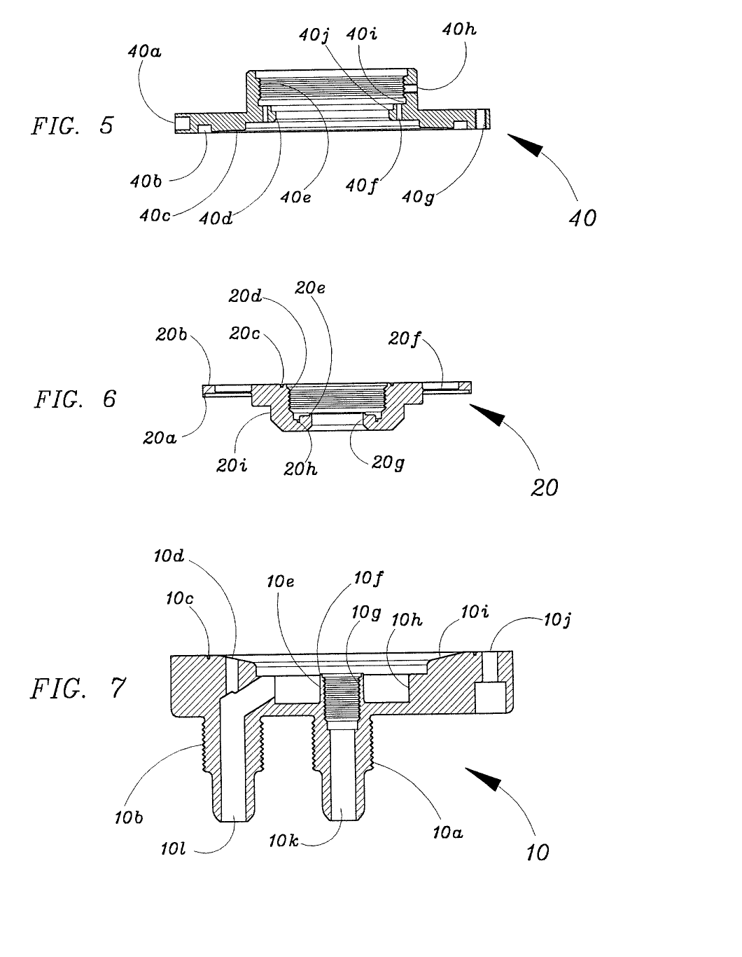

As shown in FIGS. 4, and 7, plurality of sleeves 12 are inserted in plurality of radially located holes 10j. Body 10, receives sensing element 20 with annular tongue 20a press-fitted in annular groove 10c. Clearance hole 20g slides over raised boss 10e maintaining a predetermined clearance 100a as shown in FIG. 3. The clearance hole 20g stays concentric to the raised boss bore 10e, by controlling dimensional clearance between 20i of the sensing element and the counter bore 10h, of the body. Referring to FIGS. 5 and 6, sensing element 20, receives retaining flange 30 with annular groove 30b laying over annular ring 20b. As shown in FIGS. 3, 4 and 5, washer 14 is installed and fastener 16 engages threaded tap 30g. As plurality of fastener 16 are tightened, material interference between 20a and 10c create a leak tight joint. A predetermined tapered surface30c allows a gap to be established with the thin and flexible membrane 20f to allow vertical movement and overpressure protection against rupture of the sensing element 20. Referring to FIGS. 3, 7 and 11, control element 30 is threaded into body 10 with 30a engaging 10g and annular groove 30e engaging with interference, annular tongue 10f. As shown in FIG. 3, controlling element 30, becomes a fixed and integral part of body 10. Maintaining dimensional concentricity between body 10, sensing element 20 and controlling element 30, annular groove 30b and annular tongue 20e co-align to form the control orifice of this pressure regulating device.

As shown in FIGS. 3, and 10, chemically inert plug 50, is threaded into sensing element 20 with annular tongues 50a and 50d engage annular grooves 20h and 20c with a predetermined amount of material interference to form a leak tight joints.

Referring to FIGS. 3, 4, 5, 6, 9 and 10, spring 90 is installed with leading coil 90a resting on seat 50j and flange 60b of spring retainer 60, compressing on the trail coil as thread 60a of spring retainer 60 engages 50e threads of the sensing element plug 50. As spring 90 is compressed, annular tongue 20e on sensing element 20 is lifted in upward direction to engage a predetermined amount with annular groove 30b on controlling element 30 forming a leak tight joint under in non-operating condition of the pressure regulating device.

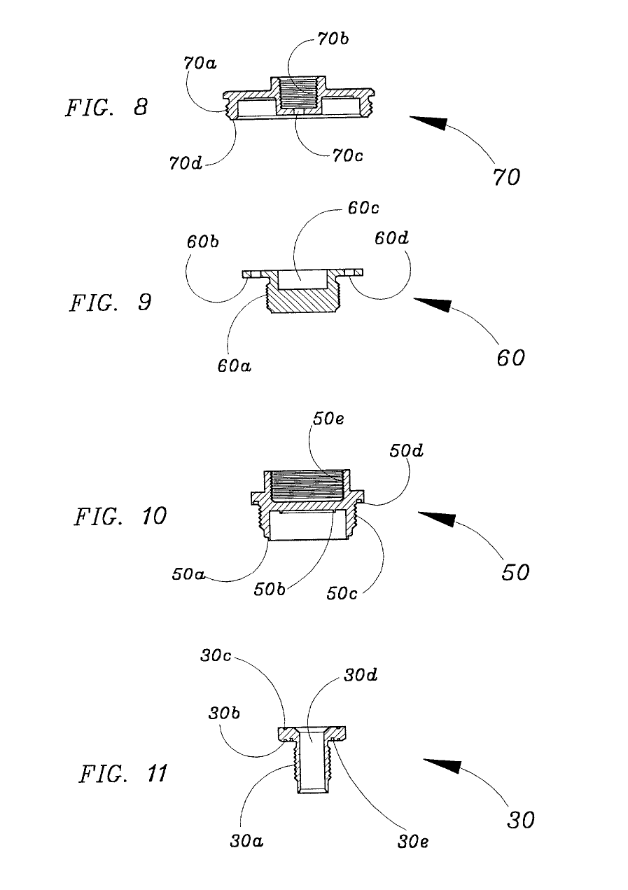

Referring to FIGS. 3, 4, 5 and 8, “O” ring 94 is installed in seat 50i of retaining flange 50 followed by engaging thread 70a of the reference pressure port 70, with threads 50e of the retaining flange 50 until leading edge 70d compresses the “O” ring by a predetermined amount. Set screw 92 locks reference pressure port in place through threaded tap hole 30h of the retaining flange 50.

As shown in FIGS. 3 and 4, cover 80 is installed and is locked in place by plurality of chemically inert pins 96 through holes 80a and 50a.

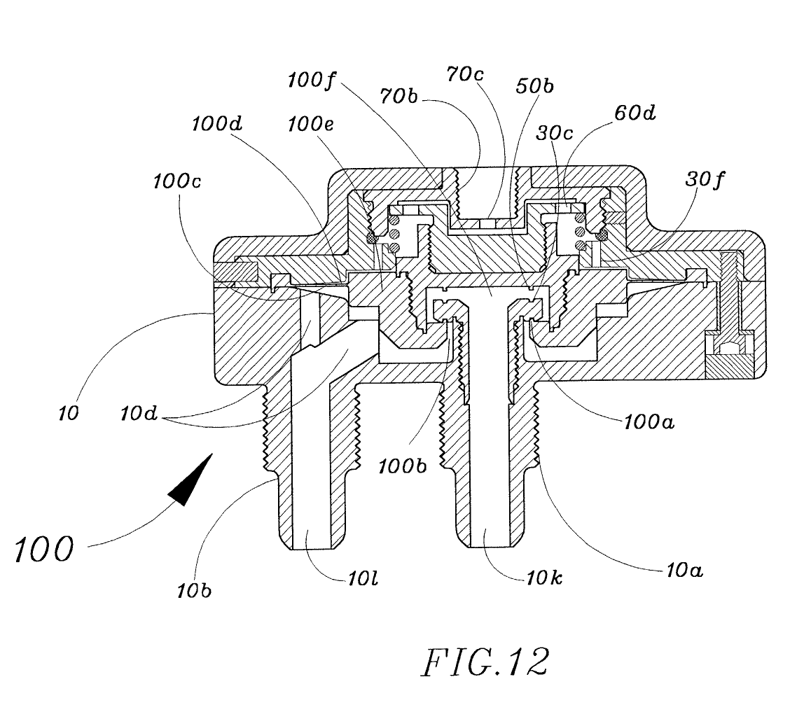

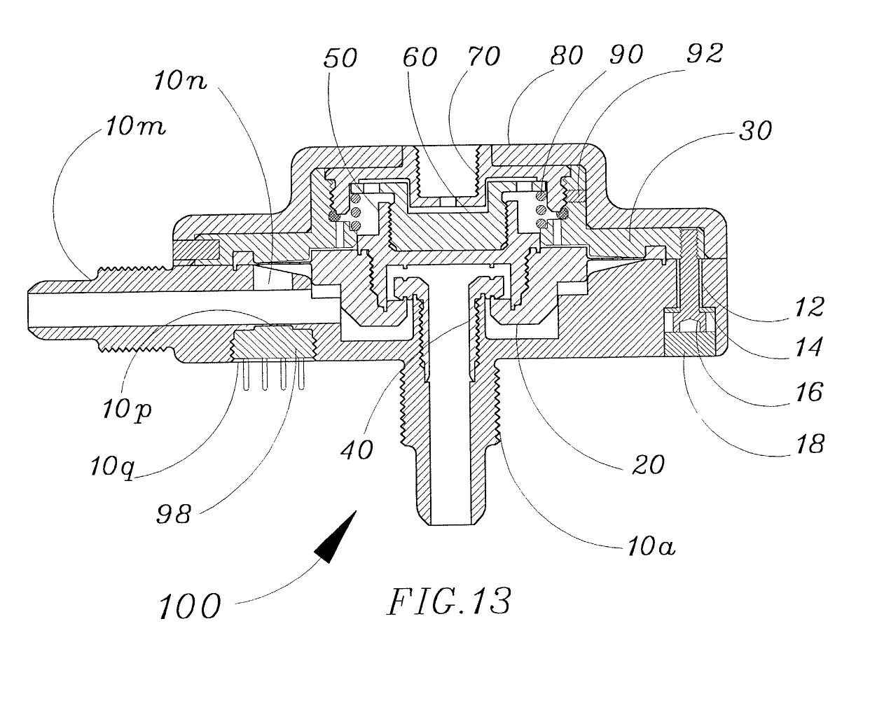

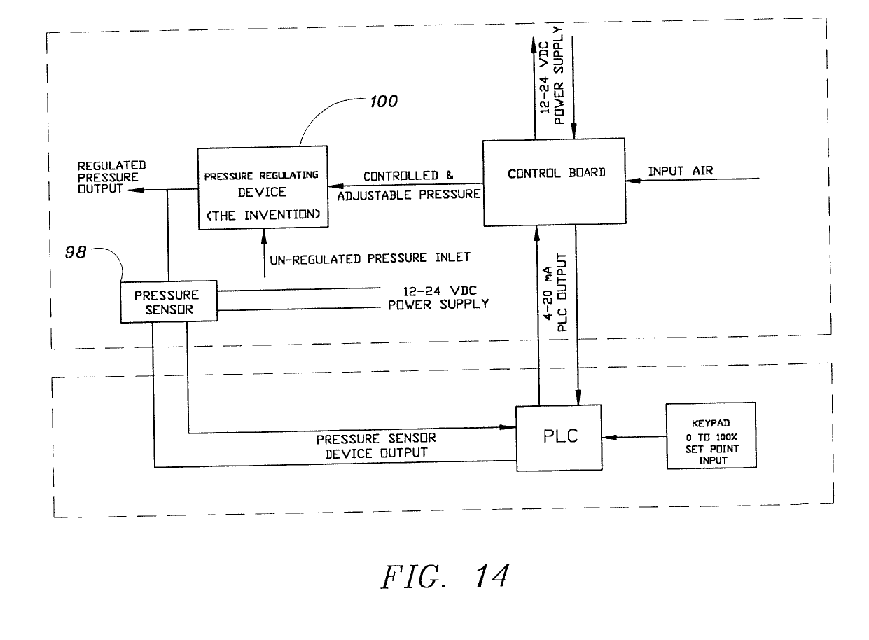

Referring now to FIG. 12, working fluid (not shown) with unregulated pressure is applied to the inlet 10a through passageway 10k to fill cavity 100f creating a resultant force in upward direction which causes seal joint 100a to further close leak tight. A desired reference pressure is applied to port 70 which through hole 70c and a plurality of holes 30f is distributed over the top side 100d of the sensing membrane assembly 100e. Because of a predetermined large effective area ratio between sensing element assembly 100e and seal joint 100a, at a given applied reference pressure, the sensing element assembly 100e will move downward hence disengaging seal joint 100a allowing fluid to enter outlet port 10b through passageways 10b, 10d and 10l. Fluid continues to flow as long as the outlet pressure at the lower side of the sensing element assembly 100c, remains just below the reference pressure at the top of the sensing element assembly 10d. When the fluid is not consumed at outlet port 10b and fluid pressure at 100c is increased to just above the reference pressure at 100d, the sensing element assembly 100e moves upward and causes the seal joint 100a to close. This decreasing and increasing of fluid pressure at the outlet passageway 10 d, 10l and 100c, causes the seal joint 100a to open and close frequently as a function of fluid consumption down stream of the outlet 10b. Because of fast response of the sensing element assembly 100e and large flow passage 100b, this innovative pressure regulator design has less resistance to flow resulting in high Cv, factor through out.

Another innovative feature of this invention is its ability to close automatically, by engaging tongue 50b into groove 30c when the inlet pressure at cavity 100f falls below the reference pressure at 100d. This innovative feature prevents fluid drainage when supply fluid entering through inlet 10a is depleted and line pressure is reduced below the desired reference pressure at 10d.

### A SECOND EMBODIMENT

Reference will now be made to FIG. 13, which illustrate a second embodiment of the present invention in which the outlet port 10m makes a 90 degree angle with the inlet port 10a and a prefabricated pressure sensor 98, is installed at the outlet port 10m. A thin wall membrane 10p is machined into body 10 through hole 10n, and the lower side of the body 10q. Membrane 10p prevent fluid contact with the sensor 98, which provide an electrical signal proportional to the outlet pressure at 10n. This signal can be processed further to adjust reference pressure to port 70, hence making this invention an automatic closed loop control pressure regulating module as shown in FIG. 14, the detail of which will be addressed in future patent application.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications, and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which point out and distinctly claim the subject matter of the invention:

1. A pressure regulating device adapted to regulate pressure of a fluid, including A body member made of an inert material that does not react chemically with the fluid in contact.
Said body member having a sealing tongue or groove, an inlet into which the fluid is introduced and an outlet from which fluid at regulated pressure exits,
A sensing element with a center hole made of an inert material that does not react chemically with the fluid in contact,
Said sensing element having a sealing tongue or groove that is clamped on to said body to create a leak tight joint,
A controlling element made of an inert material that does not react chemically with the fluid in contact,
Said controlling element having sealing tongues or grooves installed and fixed into said body through the center hole of said sensing element,
A sensing element plug with sealing tongues or grooves that is installed into the center hole of said sensing element which closes said center hole to form a leak tight sensing element assembly,
Said sensing element assembly is spring loaded to engage tongue and groove of said sensing element assembly and said controlling element,
A reference pressure port for applying a desired level of pressure to opposite side in contact with liquid of said sensing element assembly to regulate pressure at the outlet of said body:

2. A pressure regulating device of claim 1 where portion of the interior surface of a retaining flange overlies and clamps down on a portion of the sensing element using a plurality of radially located hardware.

3. A pressure regulating device of claim 1 having a pressure sensor installed at the device outlet to sense and produce an electrical signal proportionate to the regulated pressure.

4. A pressure sensing device of claim 3 where a thin wall diaphragm is machined into the body to protect the pressure sensor from contacting the working fluid.

5. A pressure sensing device of claim 1 where a portion of the inner surface of the retaining flange has a profile that maintains a gap between the exterior mating surface of the sensing element assembly.

6. A pressure sensing device of claim 5 where the retaining flange accepts an “O” ring and a reference pressure port for application of reference pressure to control output pressure.

7. A pressure regulating device of claim 6 with exposed exterior surfaces made from chemically inert material.

8. A pressure regulating device of claim 1 with ratio between the surface area of the sensing element to sealing area of the controlling element is in is greater than 10.

9. A pressure sensing device in claim 1 where it closes automatically when inlet pressure falls below reference pressure.

10. A pressure sensing device in claim 3 where the pressure sensor electrical signal can be use to control the reference pressure for automatic closed loop operation.
